(19) United States
(12) Patent Application Publication
(10) Pub. No.: US 2026/0282192 A1
(43) Pub. Date: Sep. 17, 2026

(54) REMOTE-CONTROLLED LIGHTING SYSTEM

(71) Applicant: KAI CHEN, Shenzhen (CN)

(72) Inventor: KAI CHEN, Shenzhen (CN)

(21) Appl. No.: 19/675,491

(22) Filed: May 13, 2026

(51) Int. Cl. H05B 47/135; F21V 23/04; H05B 47/155; H05B 47/175; H05B 47/19

(52) U.S. Cl. CPC H05B 47/135; F21V 23/0435; H05B 47/155; H05B 47/19; H05B 47/196; H05B 47/1985

(57) ABSTRACT

Provided is a remote-controlled lighting system, which includes a remote controller, at least one lighting fixture, and a controller configured for each lighting fixture. A dip switch component is used to provide a unique identification for a corresponding lighting fixture. The remote control is provided with control buttons and gear selection buttons. Each gear selection button is used to send a target gear remote control command carrying a corresponding button identifier to the main control unit. When the button identifier in a received target gear remote control command matches a current identity identifier of the corresponding lighting fixture, the main control unit responds to the control command of the control button to drive the corresponding lighting fixture to perform a corresponding lighting action. Thus, the configuration and maintenance cost of lighting zoning is reduced, and the lighting area division can be adjusted without rewiring.

### TECHNICAL FIELD

The present disclosure relates to the field of lighting technologies, and in particular, to a remote-controlled lighting system.

### BACKGROUND

As indoor lighting fixtures are widely used in commercial spaces, office spaces, and home environments, the demand for zone control of downlight is becoming increasingly prominent. Users expect to achieve independent control switches, dimming, etc. for lighting fixtures in different areas, such as independent control of main and auxiliary lights in the living room and zone control in different areas of the office workstation, to adapt to lighting management in diverse scenarios. In existing technology, hard wired grouping is commonly used to achieve zone control, that is, during the construction phase, control cables are separately laid for each lighting zone, and the power or control lines of all lamps in that zone are connected to the same circuit switch or relay. When operating the corresponding switch or relay, only the lamps in that circuit can be controlled, achieving “one switch controls one zone”.

However, due to the fixed wiring and partition logic during the on-site construction phase, if the lighting area partition needs to be adjusted later, the cables must be re-laid, which is cumbersome to operate, has a long construction period, and is prone to control failure due to wiring errors, rendering it unsuitable for dynamic partition requirements such as commercial spaces and office spaces.

### SUMMARY

This application provides a remote-controlled lighting system that can reduce the configuration and maintenance costs of lighting zones, and can quickly adjust the lighting zone division without rewiring.

The present application provides a remote-controlled lighting system, including: a remote controller, at least one lighting fixture, and a controller configured for each lighting fixture;
the controller includes a main control unit, a dip switch component connected to the main control unit, and a wireless communication unit; the dip switch component includes a plurality of gear switches for setting unique identity identifier for a corresponding lighting fixture;
the remote control is wirelessly connected to the wireless communication unit and is provided with control buttons and a plurality of gear selection buttons corresponding to the number of the gear switches; each of the gear selection buttons is configured to send a target gear remote control command carrying a corresponding button identifier to the main control unit; when the button identifier in a received target gear remote control command matches a current identity identifier of the corresponding lighting fixture, the main control unit responds to the control command of the control button to drive the corresponding lighting fixture to perform a corresponding lighting action; otherwise, it does not respond to the control command of the control button.

In some embodiments of the present disclosure, the type of the identity identifier is any one of numbers, letters, combinations of numbers and letters, and special symbols, and the type of button identifier is any one of numbers, letters, combinations of numbers and letters, and special symbols, with each button identifier matching a unique identity identifier.

In some embodiments of the present disclosure, the dip switch component includes N gear switches, which are respectively corresponded to 1 to N numeric identity identifiers for the corresponding lighting fixture; the gear selection buttons of the remote control are configured to be 1 to N numerical buttons, and the N numerical buttons correspond to the 1 to N button identifiers; the 1 to N button identifiers are matched one-to-one with the 1 to N numeric identity identifiers, where N is a natural number and N≥2.

Beneficial effect: in the remote-control lighting system of the present application, each lighting fixture is provided with a unique identity identifier through a corresponding dip switch component. The remote control sends a target gear remote control command carrying the corresponding button identifier through the gear selection button. The main control unit of the lighting fixture matches the received button identifier with the identity identifier of the lighting fixture. Only when the button identifier matches the identity identifier, the main control unit responds to the control command of the remote control and perform lighting actions such as switching, dimming, and color adjustment. When the identification does not match, the main control unit directly blocks all control command without any action, thus achieving independent partition or group control of multiple sets of lamps. The identity identification of this application is directly set by the physical dip switch component, and the area division logic is directly bound to the dip gear state, without relying on fixed wiring, factory preset addresses or complex software code matching. During use, if the lighting partition needs to be re divided, users can adjust the gear by directly tapping the dip switch component on site according to the actual scene needs, and the identity identification of the corresponding lighting fixtures can be modified in real time without disassembling the lamps or rewiring. After modifying the dip gear, the partition identity of the lighting fixtures is updated immediately. The corresponding gear selection button on the remote control can be used to select it, thereby achieving quick control, convenient and low-cost implementation of re partitioning and dynamic adjustment of lighting zones, enabling the lighting system to flexibly adapt to various application scenarios such as changes in scene layout and usage requirements.

### BRIEF DESCRIPTION OF DRAWINGS

FIG. 1 is a schematic structural diagram of a remote-controlled lighting system according to an embodiment of the present application.

FIG. 2 is a schematic diagram of a connection between a remote control and a controller in an embodiment of the present application.

FIG. 3 is a circuit schematic diagram of the controller in an embodiment of the present application.

FIG. 4 is a schematic diagram of an operation interface of the remote control in an embodiment of the present application.

FIG. 5 is an application scenario diagram of the remote-control lighting system according to an embodiment of the present application.

### DESCRIPTION OF EMBODIMENTS

The following provides further detailed explanations of the present application in combination with the accompanying drawings.

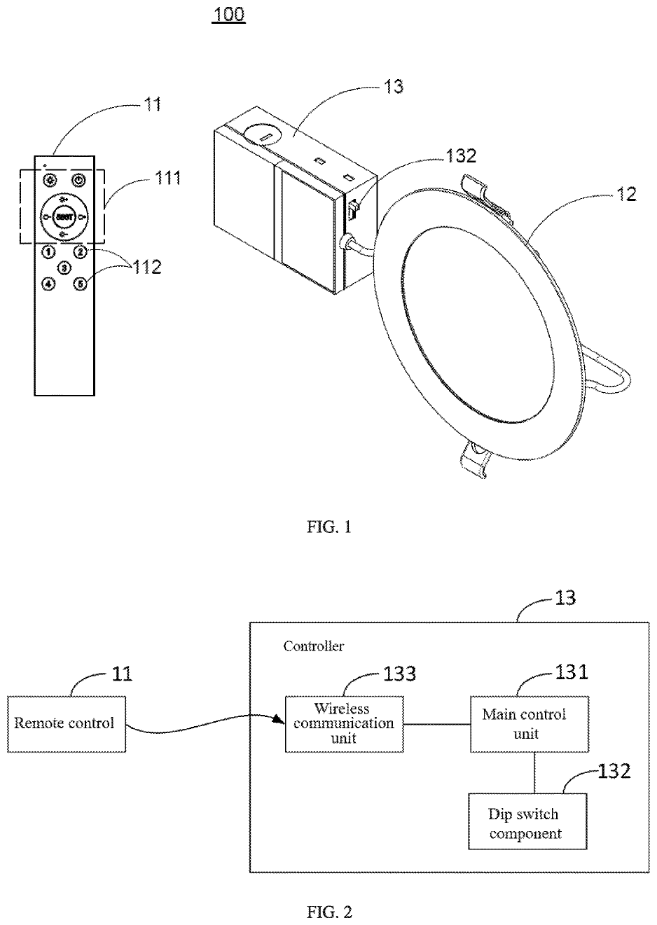

Referring to FIGS. 1 and 2, the embodiment of the present discloses a remote-controlled lighting system 100, which includes a remote controller 11, at least one lighting fixture 12, and a controller 13 configured for each lighting fixture 12. That is, each lighting fixture 12 corresponds to an independent controller 13, and the controller 13 is used to drive the corresponding lighting fixture 12 to work.

Where, the controller 13 includes a main control unit 131, a dip switch component 132, and a wireless communication unit 133. The dip switch component 132 and the wireless communication unit 133 are both connected to the main control unit 131 to achieve signal transmission and instruction interaction. The dip switch component 132 includes a plurality of gear switches. By toggling different gear switches, a unique identity identifier can be provided for the corresponding lighting fixture 12. This identity identifier serves as an identity code for the lighting fixture 12 and can distinguish between lighting fixtures in different lighting areas or different lighting fixtures within the same lighting area.

The remote control 11 is wirelessly connected to the wireless communication unit 133. The remote control 11 is provided with two types of function buttons, one is the control button 111 for executing lighting regulation, and the other is a plurality of gear selection buttons 112 corresponding to the number of the gear switches. Each gear selection button 112 corresponds to a unique button identifier, and each button identifier matches a unique identity identifier. The controller 13 may also include a storage unit for storing a matching relationship between button identifiers and identity identifiers. After pressing any gear selection button 112, the remote control 11 will broadcast and send the target gear remote control command carrying the corresponding button identifier to all controllers 13 in the space. After receiving the target gear remote control command, the main control unit 131 of the controller 13 compares the button identifier in the target gear remote control command with the identity identification provided by its own dip switch component 132. If the two match, the main control unit 131 enters a response state, receives and executes the control command sent by the control button 111, and then drives the lighting fixture 12 to perform the corresponding lighting action. If the two do not match, the main control unit 131 will block all control commands, and the lighting fixtures 12 will maintain their original working state without performing any actions, thus achieving interference free and accurate lighting fixture grouping or zoning control.

In an implementation mode of the present application, the type of identity identifier can be any one of numbers, letters, combinations of numbers and letters, special symbols (such as #, &, *, etc.), and the type of the button identifier can be any one of numbers, letters, combinations of numbers and letters, or special symbols. Each button identifier matches a unique identity identifier. For example, both identity identifier and button identifier can be numbers, or one of them can be a number and the other can be a letter, without any limitations.

Where the identifier printed or pasted on the surface of the gear selection button 112 on the remote control 11 can be the corresponding button identifier. An outer surface of the controller 13 is further provided with an identifier, which can also be a corresponding identity identifier. The position of the identifier corresponds to the position of the gear switch. For example, if the button identifier corresponding to a gear selection button 112 is 1, then the identifier printed or pasted on the gear selection button 112 is also 1. If the identity identifier corresponding to a certain gear switch is 1, then the outer surface of controller 13 is also printed or pasted with the identifier 1 corresponding to the position of the gear switch, rendering it convenient for a user to intuitively control and define zones or groups.

In an implementation mode of the present application, the dip switch component 132 includes N gear switches, each of the gear switches used to set a numeric identity identifier of 1 to N for the corresponding lighting fixture, where N is a natural number and N≥2, which can meet the multi zone lighting needs of commercial, office, and home scenarios. Correspondingly, the gear selection button 112 of the remote control 11 is provided with N numeric buttons, and the button identifiers corresponding to the N numeric buttons are 1 to N. The button identifiers from 1 to N are matched one-to-one with the numeric identity identifiers from 1 to N, and the button identifier 1 is matched with the numeric identity identifier 1, and so on, thus achieving intuitive control of one numeric button corresponding to one lamp group or partition. The user does not need to memorize complex codes, and the operation is simple and easy to understand.

For example, N can be 5, which means there are 5 gear switches and 5 numeric buttons. This allows for separate control of 5 lighting areas or 5 different lighting fixtures within the same lighting area. Of course, N can also be 6, 10, 15, or other numerical values to achieve more partitioning or grouping.

In an implementation mode, the type of the identity identifier provided for the lighting fixture 12 can also be letters or a combination of letters and numbers, or symbols such as # and *. For example, it can be a total of 5 sets of identity identifiers: A, B, C, D, and E. At this time, the gear selection button on the remote control 11 can be arranged to correspond to the five letter buttons A, B, C, D, and E, and the corresponding button identifiers for the letter buttons are the five letters A, B, C, D, and E.

Where the dip switch component 132 can be a DIN (Dual Inline Package Switch) dip switch.

In the following description, examples of the dip switch component 132 having 5 gear switches for explanation will be described.

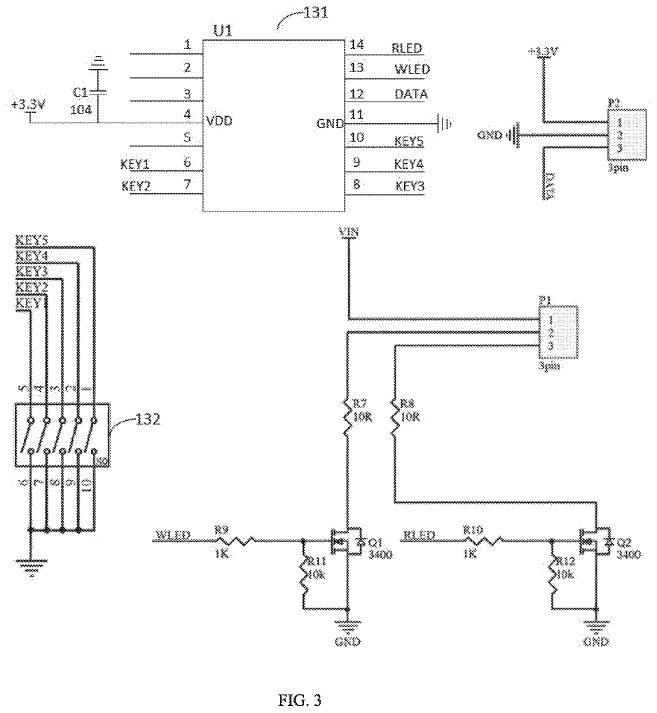

Referring to FIG. 3, in an implementation mode of the present application, the main control unit 131 includes a main control chip U1 and a capacitor C1. The main control chip U1 is a core control component, and the capacitor C1 is a voltage stabilizing and filtering capacitor to ensure the voltage stability of the main control chip U1. One end of the capacitor C1 is connected to a 4^{th} pin of the main control chip U1, and the other end is grounded. Where the 4^{th} pin of the main control chip U1 is used to connect the working voltage of 3.3V, a 11^{th} pin of the main control chip U1 is grounded, and a 6^{th} pin, a 7^{th} pin, an 8^{th} pin and a 9^{th} pin of the main control chip U1 are respectively connected to 5 gear switches of the dip switch component 132 one by one. The main control chip U1 detects the high and low voltage state of the corresponding pins in real time, reads the current gear switch of the dip switch component 132, and then obtains the identity identifier of the corresponding lighting fixture 12.

It can be understood that the number of pins of the main control chip U1 can be expanded according to the number of gear switches. When the dip switch component 132 has more gear switches, such as 8 gear switches, i.e. N=8, the main control chip U1 also has corresponding 8 pins connected to each of the 8 gear switches one by one.

The main control unit 131 also includes an interface P2, and the wireless communication unit 133 is connected to a 12^{th} pin of the main control chip U1 through a 3^{rd} pin of the interface P2. The wireless communication unit 133 is used to receive remote control commands from the remote control 11, including target gear remote control commands and control commands, and transmit the remote control commands to the main control chip U1, thereby achieving wireless data exchange between the remote control 11 and the main control chip U1. The interface P2 can simultaneously provide 3.3V working voltage and grounding path for the wireless communication unit 133, ensuring stable power on and normal signal transmission and reception of the wireless communication unit 133.

Where the wireless communication unit 133 can be a 2.4G wireless communication unit.

Continuing to refer to FIG. 3, the main control unit 131 further includes an interface P1, a resistor R7, a resistor R8, a resistor R9, a resistor R10, a resistor R11, a resistor R12, a Metal Oxide Semiconductor Field Effect Transistor, (MOS) transistor Q1, and a MOS transistor Q2. The interface P1 is connected to the lighting fixture, a collector electrode of the MOS transistor Q1 is connected to a 2^{nd} pin of the interface P1 through the resistor R7, a collector electrode of the MOS transistor Q2 is connected to a 3^{rd} pin of the interface P1 through the resistor R8, a source electrode of the MOS transistor Q1 is grounded, the resistor R11 is connected between a gate electrode and a source electrode of the MOS transistor Q1, a 13rd pin of the main control chip U1 is connected to a gate electrode of the MOS transistor Q1 through the resistor R9, a source electrode of the MOS transistor Q2 is grounded, and the resistor R12 is connected between a gate electrode and a source electrode of the MOS transistor Q12. A 14^{th} pin of the main control chip U1 is connected to a gate electrode of the MOS transistor Q2 through the resistor R10. The main control chip U1 outputs a PWM adjustment signal through a 13rd pin and a 14^{th} pin to control the conduction and turn off of the MOS transistor Q1 and the MOS transistor Q2, thereby driving the lighting fixture 12 to complete switching, dimming, color adjustment and other actions.

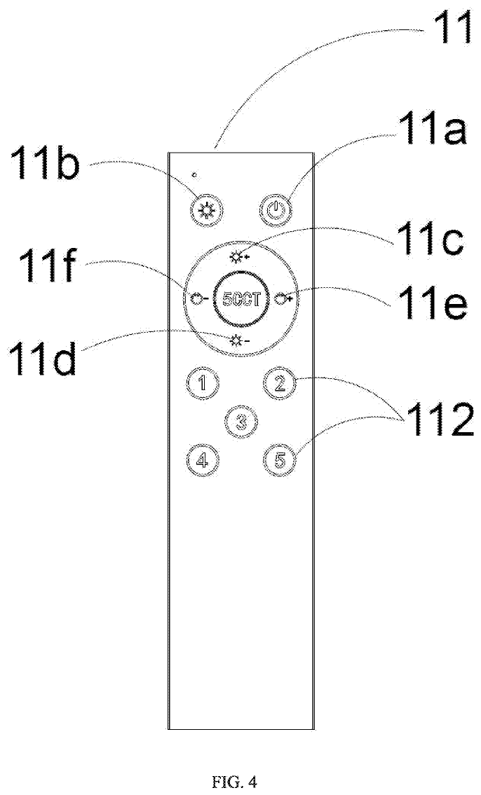

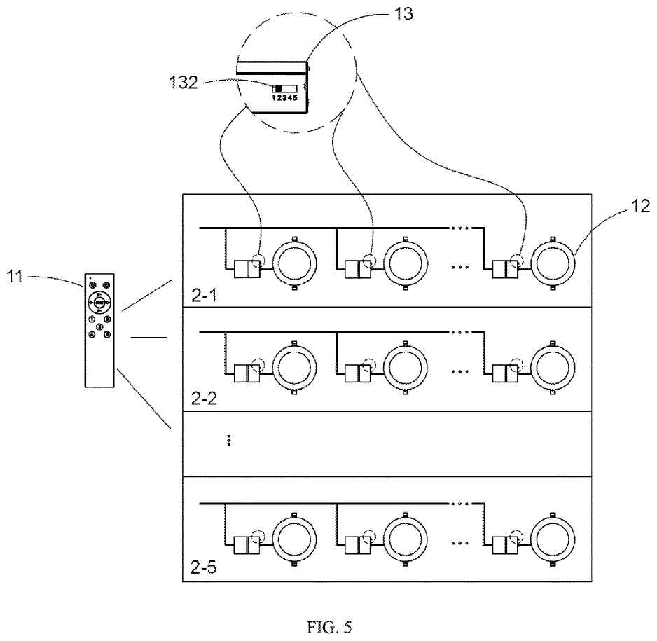

Referring to FIG. 4, there are five gear selection buttons 112 on the remote control 11, which are labeled as 1, 2, 3, 4, and 5. The control buttons 111 include a main switch button 11a, a lamp switch button 11b, a brightness+adjustment button 11c, a brightness−adjustment button 11d, a color temperature+adjustment button 11e, and a color temperature−adjustment button 11f. The lighting actions include turning on and off lights, adjusting brightness and color temperature. Where the main switch button 11a can achieve global standby control, the lamp switch button 11b controls the on and off of the target lighting fixture 12, the brightness+adjustment button 11c and brightness−adjustment button 11d can adjust the brightness of the lamp, and the color temperature+adjustment button 11e and color temperature−adjustment button 11f can switch and adjust the temperature of the lamp.

Through the lighting system 100 of this application, pressing any number of numerical buttons on the remote control 11 controls the lighting fixture by turning the dip switch component 132 to the corresponding number gear switch.

The number button 1 on the remote control 11 is pressed, and at this time, the remote control 11 controls a lighting fixtures that is coded to the gear switch 1. The lighting fixtures that are coded to gear switches 2, 3, 4, and 5 are not controlled by the remote control 11.

The number button 2 on the remote control 11 is pressed, and at this time, the remote control 11 controls the lighting fixture that is coded to the gear switch 2. The lighting fixtures that are coded to gear switches 1, 3, 4, and 5 are not controlled by the remote control 11.

The number button 3 on the remote control 11 is pressed, and at this time, the remote control 11 controls the lighting fixture that is coded to the gear switch 3. The lighting fixtures that are coded to gear switches 1, 2, 4, and 5 are not controlled by the remote control 11.

The number button 4 on the remote control 11 is pressed, and at this time, the remote control 11 controls the lighting fixture that is coded to the gear switch 4. The lighting fixtures that are coded to gear switch 1, gear switch 2, gear switch 3, and gear switch 5 are not controlled by the remote control 11.

The number button 5 on the remote control 11 is pressed, and at this time, the remote control 11 controls the lighting fixture that is coded to the gear switch 5. The lighting fixtures that are coded to gear switches 1, 2, 3, and 4 are not controlled by the remote control 11.

Therefore, in the remote-control lighting system 100 of the present application, each lighting fixture 12 is provided with a unique identity identifier through the corresponding dip switch component 132. The remote control 11 sends a target gear remote control command carrying the corresponding button identifier through the gear selection button. The main control unit 131 of the controller 13 matches the received button identifier with the identity identifier of the lighting fixture 12. Only when the button identifier matches the identity identifier, the main control unit 131 responds to the control instructions of the remote control 11 and performs lighting actions such as switching, dimming, and color adjustment. When the identification does not match, the main control unit 131 directly blocks all control commands without any action, thus enabling independent zone control of multiple sets of lighting fixtures in the same space. Through the above method, the lighting system 100 can achieve separate control of lighting fixtures in different lighting areas, or control different lighting fixtures in the same lighting area separately.

For example, as shown in FIG. 5, there are five lighting areas in an office area, namely lighting area 2-1, lighting area 2-2, . . . , lighting area 2-5. For example, they can correspond to workstation area, printing area, tea area, negotiation area, and information area. The identity identifications of the lighting fixtures 12 in the same lighting area are the same, while the identity identifications of the lighting fixtures 12 in different lighting areas are not the same. That is, the dip switch components 132 in the same lighting area are all dialed to the same gear switch, and the dip switch components in different lighting areas are dialed to different gear switches. Therefore, the lighting fixtures 12 in different lighting areas can be individually controlled through the remote control 11.

Besides that, in the lighting system 100 of the present application, the identity identifier of the lighting fixture 12 is directly set by the physical dip switch component 132, and the area division logic is directly bound to the dip gear state, without relying on fixed wiring, factory preset addresses, or complex software coding. During use, if the lighting partition needs to be re divided, the user can adjust the gear by directly tapping the dip switch component 132 on site according to the actual scene requirements, and the corresponding identity identifier of the lighting fixture 12 can be instantly modified without disassembling the fixture or rewiring. After modifying the dip gear, the partition identity of the lighting fixture 12 is immediately updated. It can be controlled by selecting the corresponding gear button on the remote control 11, thus quickly, conveniently, and cost effectively realizing the redivision and dynamic adjustment of the lighting partition. The lighting system can flexibly adapt to changes in scene layout and various application scenarios such as changes in usage requirements.

This specification uses specific examples to explain the principles and implementation modes of the present disclosure. The above embodiments are only used to help understand the method and core idea of the present disclosure. Meanwhile, for those skilled in the art, there may be changes in the specific implementation and application scope based on the idea of the present disclosure. In summary, the content of this specification should not be understood as limiting the present disclosure.

What is claimed is:

1. A remote-controlled lighting system, comprising: a remote controller, at least one lighting fixture, and a controller configured for each lighting fixture;
the controller comprises a main control unit, a dip switch component connected to the main control unit, and a wireless communication unit; the dip switch component comprises a plurality of gear switches for setting unique identity identifier for a corresponding lighting fixture;
the remote control is wirelessly connected to the wireless communication unit and is provided with control buttons and a plurality of gear selection buttons corresponding to the number of the gear switches; each of the gear selection buttons is configured to send a target gear remote control command carrying a corresponding button identifier to the main control unit;
when the button identifier in a received target gear remote control command matches a current identity identifier of the corresponding lighting fixture, the main control unit responds to the control command of the control button to drive the corresponding lighting fixture to perform a corresponding lighting action; otherwise, it does not respond to the control command of the control button.

2. The remote-controlled lighting system according to claim 1, wherein the type of the identity identifier is any one of numbers, letters, combinations of numbers and letters, and special symbols, and the type of button identifier is any one of numbers, letters, combinations of numbers and letters, and special symbols, with each button identifier matching a unique identity identifier.

3. The remote-controlled lighting system according to claim 2, wherein the dip switch component comprises N gear switches, which are respectively corresponded to 1 to N numeric identity identifiers for the corresponding lighting fixture;
the gear selection buttons of the remote control are configured to be 1 to N numerical buttons, and the N numerical buttons correspond to the 1 to N button identifiers;
the 1 to N button identifiers are matched one-to-one with the 1 to N numeric identity identifiers, where N is a natural number and N≥2.

4. The remote-controlled lighting system according to claim 3, wherein the main control unit comprises a main control chip U1 and a capacitor C1;
a 4^{th} pin of the main control chip U1 is used to connect to a working voltage of 3.3V, an 11^{th} pin of the main control chip U1 is grounded, one end of the capacitor C1 is connected to the 4^{th} pin of the main control chip U1, and the other end is grounded;
the main control chip U1 also has N pins connected to the N gear switches one by one.

5. The remote-controlled lighting system according to claim 4, wherein the main control unit further comprises an interface P2, and the wireless communication unit is connected to a 12^{th} pin of the main control chip U1 through a 3^{rd} pin of the interface P2.

6. The remote-controlled lighting system according to claim 4, wherein the main control unit further comprises an interface P1, a resistor R7, a resistor R8, a resistor R9, a resistor R10, a resistor R11, a resistor R12, a MOS transistor Q1, and a MOS transistor Q2;
the interface P1 is connected to the lighting fixture, a collector electrode of the MOS transistor Q1 is connected to a 2^{nd} pin of the interface P1 through the resistor R7, a collector electrode of the MOS transistor Q2 is connected to a 3^{rd} pin of the interface P1 through the resistor R8, a source electrode of the MOS transistor Q1 is grounded, the resistor R11 is connected between a gate electrode and a source electrode of the MOS transistor Q1, a 13rd pin of the main control chip U1 is connected to a gate electrode of the MOS transistor Q1 through the resistor R9, a source electrode of the MOS transistor Q2 is grounded, the resistor R12 is connected between a gate electrode and a source electrode of the MOS transistor Q12, and a 14^{th} pin of the main control chip U1 is connected to a gate electrode of the MOS transistor Q2 through the resistor R10.

7. The remote-controlled lighting system according to claim 1, wherein the control buttons comprise a main switch button, a lamp switch button, a brightness adjustment button, and a color temperature adjustment button, and the lighting action comprises turning on and off the lamp, adjusting the brightness, and adjusting the color temperature.

8. The remote-controlled lighting system according to claim 1, wherein the wireless communication unit is a 2.4G wireless communication unit.

9. The remote-controlled lighting system according to claim 1, wherein the dip switch component is a dip switch.
